(19) United States
(12) Patent Application Publication
(10) Pub. No.: US 2008/0142161 A1
(43) Pub. Date: Jun. 19, 2008

(54) APPARATUS FOR PARTIAL BONDING OF VEHICLE COMPONENTS

(75) Inventors: Richard J. Bissdorf, Hirschhorn (DE); Helmut Gattermeier, Hirschhorn (DE); Rainer Siefert, Rothenberg (DE); Willy Siefert, Rothenberg (DE)

Correspondence Address: FOLEY AND LARDNER LLP;SUITE 500, 3000 K STREET NW, WASHINGTON, DC, 20007, US

(73) Assignee: GH-Induction Deutschland GmbH

(21) Appl. No.: 11/877,190

(22) Filed: Oct. 23, 2007

(30) Foreign Application Priority Data
Oct. 24, 2006 (DE) 102006050726.6-15

(51) Int. Cl. B29C 65/22

(52) U.S. Cl. 156/378; 156/499

(57) ABSTRACT

The present invention relates to an apparatus for partially adhesively bonding add-on automotive parts with the aid of a two-component adhesive, wherein, according to the invention, the apparatus has a current line as an induction heater, the current line has an associated clamping apparatus which has an air shower which is directed at the parts of a workpiece which is to be adhesively bonded, said parts being clamped in beneath a jaw of the clamping apparatus, with the clamping apparatus pressing the workpiece, which is to be adhesively bonded, against the induction heater.

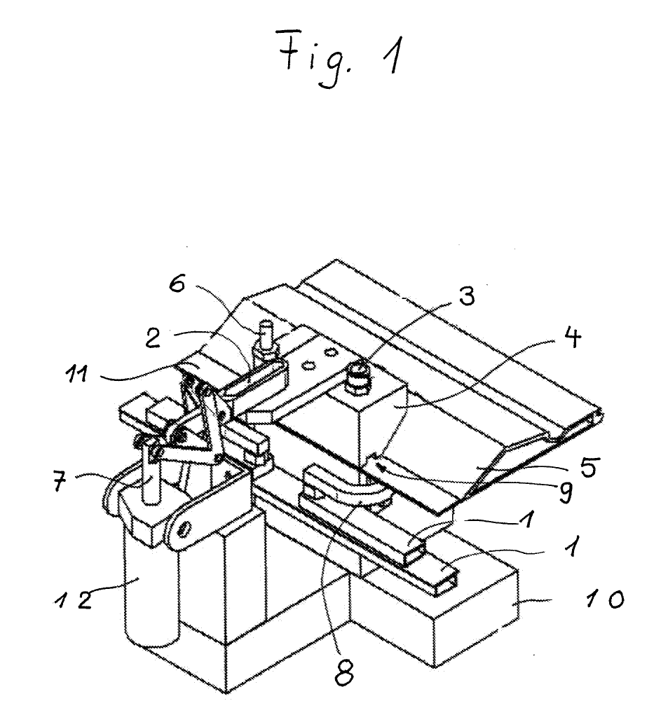

The present invention relates to an apparatus for partially curing adhesives in the seam region of, for example, add-on automotive parts, combined with a fastening apparatus. Add-on automotive parts which are adhesively bonded to another are used in the manufacture of motor vehicles.

In this case, adhesive bonding is carried out, for example, using two-component adhesives since more favorable process times can be achieved with the aid of heat treatment.

These two-component adhesives—usually based on epoxy resins and suitable, for example aminic, curing agents—are conventionally introduced between the sheet-metal parts, after which the parts are pressed together and left to react at room temperature over a time period of approximately 1 hour, in order to obtain a dimensionally stable component for production.

One disadvantage of this procedure is the relatively long cycle times.

The object of the present invention is therefore to provide a way of significantly shortening the cycle times and nevertheless obtaining dimensionally stable components.

According to the invention, this object is achieved by an apparatus for adhesively bonding add-on automotive parts with the aid of a two-component adhesive. In this case, the apparatus has an induction coil which, as an induction heater, is associated with a clamping apparatus and has an air shower which is directed at the parts of a workpiece which is to be adhesively bonded, said parts being fastened beneath a mold support of the clamping apparatus. In the process, the clamping apparatus presses the workpiece, which is to be adhesively bonded, onto the induction heater.

In this case, the invention is based on the fact that, with appropriate selection of frequency and current intensity, metal can also be heated to the temperature which is required for curing reactive adhesives by magnetic flux. The current intensities in the inductor are 400-600 amperes.

A shorter heating time results on account of the heating taking place in the interior of the metal workpiece.

The invention has also found that complete curing of the two-component adhesive at the periphery of the workpiece is not necessary in order to be able to remove the adhesively bonded parts from the apparatus. This time is normally approximately 3-5 minutes for, for example, the parts of a motor vehicle door. It has been found that the cycle times can be shortened to less than one minute if the adhesion area is cooled immediately after the introduction of heat. As a result, the viscosity of the reacting adhesive is raised to such an extent that the workpiece can be removed from the apparatus without problems and without the adhesively bonded parts being able to move in relation to one another.

In this case, cooling can be performed in a particularly simple manner by the jaw of the clamping apparatus being provided with an air supply, with the lower face of said clamping apparatus having a longitudinally extending channel via which the cooling air emerges and flows out laterally and in the process conducts heat away from the surface of the metal sheet.

The apparatus has a temperature sensor in order to be able to precisely determine the heating process and the time for cooling the adhesion area for the purpose of removal. Said temperature sensor is likewise preferably accommodated in the clamping jaw and detects the temperature of the surface of the metal sheet.

The clamping apparatus is operated with the aid of a piston and a suitable lever mechanism which, in one cylinder, can be acted on by a pressure medium, for example compressed air, so that said lever mechanism can be automatically controlled, with the clamping apparatus being released when the workpiece is at the predefined temperature detected by the sensor.

In order to be able to focus the electromagnetic field, which generates the increase in temperature in the workpiece by means of an eddy current, as is particularly important in the case of aluminum, the induction current conductors have, on both sides, so-called field concentrators, for example in the form of mutually insulated, perpendicular iron plates, whose upper edges laterally bound the magnetic field generated between them by conductors, and direct said magnetic field such that the introduction of energy is increased.

The inductor feed lines themselves are laid one above the other in a bifilar manner, that is to say the current flow directions oppose one another in the upper and lower conductors, and this reduces energy losses. The distance between the upper and lower conductor sections is preferably approximately 1 mm.

The conductor forms a loop in the jaw region, so that said loop is situated beneath the clamping jaw and the feed lines are situated in front of it, with the clamping jaw pressing the workpiece onto the loop which thus forms the abutment.

The present invention is explained in greater detail with reference to the accompanying FIGURE.

The FIGURE shows a current line 1, 1′ which is laid in a bifilar manner on a support 10, with the upper line forming a loop 8.

A second workpiece 5, which is to be adhesively bonded at its overlapping adhesion area 11 with the aid of a two-component adhesive, is situated on the (supported) loop 8. The workpiece 5 or its adhesion area 11 is held down by a jaw 4 which presses said workpiece against the loop 8 as an abutment. As soon as a current flows in the induction current conductor 1, 1′, said current heats up the adhesion area 11, that is to say the metal sheet, which in turn gives up heat to the reactive adhesive, as a result which said reactive adhesive reacts.

The surface temperature is detected with the aid of the temperature sensor 6, and the current supply is switched off after the desired temperature, for example approximately 100° C., is reached. The adhesion area 11 is then immediately acted on by cooling air via the air shower 3 which supplies air to the adhesion area 11 via the channel 9 and cools said adhesion area. After a predefined temperature (for example 30° C.) is reached, the clamping jaw 4 is opened by means of the piston 7 of the clamping apparatus 2, and the workpiece can be removed.

In order to obtain a sufficiently high clamping action, the clamping apparatus 2 has a corresponding lever mechanism and the piston 7 is driven by a pressure medium in a cylinder 12.

In the manner described above, metal vehicle body parts can be adhesively bonded considerably more quickly, the cycle times are reduced from approximately 1 hour to up to one minute, with an interconnection which is sufficiently stable for further processing being produced after such short action and reaction times following cooling.

This application claims priority from German Patent Application No. 10 2006 050 726.6-15, filed Oct. 24, 2007, all of which is incorporated herein by reference in its entirety.

### LIST OF REFERENCE SYMBOLS

1 Current line
2 Clamping apparatus
3 Air shower
4 Jaw
5 Workpiece
6 Temperature sensor
7 Pressure piston
8 Loop
9 Channel
10 Support
11 Adhesion area
12 Cylinder
13 Lever mechanism

1. An apparatus for adhesively bonding metal parts with the aid of a two-component adhesive, comprising the following features:
a) the apparatus has a current line as an induction heater,
b) the current line has an associated clamping apparatus which
c) has an air shower which is directed at the parts of a workpiece which is to be adhesively bonded, said parts being clamped in beneath a jaw of the clamping apparatus, with
d) the clamping apparatus pressing the workpiece, which is to be adhesively bonded, against the induction heater.

2. The apparatus as claimed in claim 1, wherein the temperature at the heating point of the workpiece is detected by a temperature sensor.

3. The apparatus as claimed in claim 2, wherein the temperature sensor and the air shower are arranged in the clamping jaw of the clamping apparatus.

4. The apparatus as claimed in claim 1, wherein the clamping apparatus can be operated with the aid of a pressure piston.

5. The apparatus as claimed in claim 1, wherein the induction heater is provided with field concentrators.

6. The apparatus as claimed in claim 1, wherein the induction lines are laid in a bifilar manner at a small distance from one another.

7. The apparatus as claimed in claim 1, wherein the induction line at the point of action of the jaw of the clamping apparatus is in the form of a loop.

8. The apparatus as claimed in claim 1, wherein the lower face of the clamping jaw has a channel which is open toward the workpiece and is connected to the cooling-air supply.
